(19) United States
(12) Patent Application Publication
(10) Pub. No.: US 2012/0055112 A1
(43) Pub. Date: Mar. 8, 2012

(54) SET OF PANELS, IN PARTICULAR FLOOR PANELS

(76) Inventor: Nils-Erik Engstrom, Trelleborg (SE)

(21) Appl. No.: 12/747,454

(22) PCT Filed: May 25, 2010
(86) PCT No.: PCT/EP10/03167

§ 371 Date: Apr. 7, 2011

(30) Foreign Application Priority Data
May 25, 2009 (DE) 10 2009 022 483.1

(51) Int. Cl. E04C 2/40; B23P 11/00

(52) U.S. Cl. 52/582.2; 29/428

(57) ABSTRACT

The invention refers to a set of panels, comprising a first panel having a lateral edge on which a first retaining profile is disposed, at least one second panel having a lateral edge on which a second retaining profile is disposed, which can be joined to the first retaining profile, wherein the panels are joined positively along the lateral edges by the retaining profiles in a direction parallel to a laying plane and in a direction perpendicular to the laying plane in the joined and laid state of the panels, a separate locking element associated with the first retaining profile which, during joining of the retaining profiles, moves from an assembly position into a locking position, wherein in a locking position the locking element ensures form closure at least in a direction perpendicular or parallel to the laying plane by a locking projection of the locking element engaging in a locking recess provided on the second retaining profile. The invention is characterised in that the first retaining profile and/or the locking element have retarding means which, on transition from the assembly position into the locking position, retard a movement of the locking projection in such a manner that a deformation stress is built up in the locking element during joining of the retaining profiles without the locking projection thereby resting on a surface of the second retaining profile.

The invention relates to a set of panels, in particular floor panels, comprising a first panel having a lateral edge on which a first retaining profile is disposed and at least one second panel having a lateral edge on which a second retaining profile is disposed, which can be joined to the first retaining profile.

WO 2007/008139 A1 describes a set of panels joined positively along the lateral edges by the retaining profiles in a direction parallel to a laying plane and in a direction perpendicular to the laying plane in the joined and laid state of the panels. Associated with the first retaining profile in this context is a separate locking element which, during joining of the retaining profiles, moves automatically from an assembly position into a locking position. In this case, the locking element ensures form closure in the direction perpendicular to the laying plane by a locking projection of the locking element engaging in a locking recess provided on the second retaining profile.

During joining of the retaining profiles described in WO 2007/008139 A1, the separate locking element is resiliently deformed. As a result of the resilient deformation, the locking projection is pressed against a surface of the second retaining profile during joining of the retaining profiles until the projection ultimately engages in the locking groove. The pressure exerted by the locking projection on the second retaining profile effects a pressing apart of the retaining profiles in the horizontal direction which makes it difficult to join the retaining profiles.

It is therefore the object of the invention to provide a set of panels with retaining profiles which can be joined easily.

The object forming the basis of the invention is achieved with the combination of features according to claim 1. Preferred exemplary embodiments can be deduced from the dependent claims.

The set of panels according to the invention is characterised in that the first retaining profile and/or the locking element preferably have a retarding means which, on transition from the assembly position into the locking position, retards, hinders or otherwise delays movement of a locking projection in such a manner that a deformation stress can built up in the locking element during joining of the retaining profiles without the locking projection thereby resting on a surface or contacting the second retaining profile. The presence of the retarding means can ensure that at least in a first phase of the joining of the retaining profiles, no force pressing apart the retaining profiles is acting.

In a preferred exemplary embodiment, the retarding means exerts a force on the locking projection which exceeds 10 N, typically 20 N and preferably 30 N per linear meter in the direction of a longitudinal extension of the locking element. Assuming that the force on the locking projection is 20 N and that the locking element extends completely along a lateral edge having, for example, a length of 20 cm, a force of 4 N would be required to overcome the retaining force of the retarding means so that the locking projection no longer remains in the initial position in which it is located in the assembly position of the locking element. In the initial position, the locking projection does not contact any surface and any point of the retaining profile when the two retaining profiles are placed in one another.

The retarding means can exert a force on the locking projection which exceeds 50 N per linear meter or even 100 N per linear meter. In a preferred exemplary embodiment, the force of the retarding means is even more than 150 N per linear meter.

The retarding means can comprise a press fit or tight fit which is established between the locking element and the first retaining profile when the locking element is located in the assembly position. The locking element can in this case be located firmly in a retaining groove of the first retaining profile, thereby fixing the position of the locking projection, although at least a partial region of the locking element can be resiliently deformed during joining of the retaining profiles. Due to the resilient deformation of the partial region, a deformation stress is introduced into the locking element. If the deformation stress exceeds a certain value (defined by the characteristics of the material of the locking element), the press fit can no longer hold the locking element in the retaining groove, resulting in movement of the locking projection in the direction of the locking groove of the second retaining profile. Thus, a non-positive, force locking connection is involved between first retaining profile and locking element.

Alternatively or additionally, the retarding means can comprise adhesive or the like. The force of the retarding means whereby the locking projection is held in its initial position can be adjusted by means of the choice of adhesive and the surface on which the adhesive acts.

In addition, the retarding means can comprise friction-enhancing means or magnetic means through which a force is exerted on the locking projection in order to hold this in its initial position at least for an initial phase of the joining of the retaining profiles.

In still other embodiments, the retarding means can be a sealant or adhesive, or any other material capable of maintaining the locking element in its initial position until the assembly is completed. For example, a weak adhesive, glue, or even a hook-and-pile structure can hold the locking element in place.

In preferred embodiments, the locking element can be formed in one piece. For example, the locking element can be made of thermoplastic material or thermosetting material. The locking element can be extruded or it can be an injection-moulded part. Furthermore, the locking element can also be made of metal such as, for example, aluminium, steel or copper. Other suitable materials include, cellulosic materials (e.g., fibreboard, or other deformable wood-based product), natural and synthetic rubbers, plastic materials (e.g., polyolefins) or any other elastomeric material. The material of the locking elements can also be a combination of materials, e.g., either in discrete sections (e.g, layered or as a conglomerate) or as a homogeneous mass.

It is also possible for the locking element to be formed from a plurality of parts made from the same or different materials. For example, one part of the locking element which is associated with the retarding means could be made of a soft plastic or of rubber which is pressed into a retaining groove of the first retaining profile. Another part of the locking element, for example, a locking projection, can be formed from a harder material since this, in conjunction with the locking groove of the second retaining profile, must ensure a dimensionally able positive closure between the retaining profiles.

The locking element can have a leg against which the second retaining profile presses during joining of the retaining profiles substantially in a direction perpendicular to the laying plane. The deformation stress can then be introduced into the locking element through the leg. Since the second retaining profile presses on the leg perpendicularly to the laying plane, a reaction force acts on the retaining profile which does not lead to any pressing apart of the retaining profiles in a direction parallel to the laying plane.

In a preferred exemplary embodiment, the first retaining profile comprises an upwardly directed hook element and the second retaining profile comprises a downwardly directed hook element, wherein the hook elements should ensure form closure in the direction parallel to the laying plane in the joined state. In this case, the hook elements can preferably be formed in one piece with a core of the respective panel. The core can be made of wood of MDF or HDF, plastic or a composite of wood fibres/wood particles and plastic.

Suitable core materials also include one or more of wood, fiberboard, such as high density fiberboard (HDF) or medium density fiberboard (MDF), polymer (thermosetting and thermoplastic, and in a solid, sheet or corrugated form), flaxboard, stone (e.g., ceramic, marble, slate), cardboard, concrete, gypsum, high density fiber reinforced plaster, plywood, oriented strand board, cores made from particles (including discrete pieces of wood, which can be chips, curls, flakes, sawdust, shavings, slivers, stands, wavers, wood flour, wood wool and/or fibers), and other structural materials, such as metals (e.g., brass, aluminum, steel, copper, composites, composites or alloys). In some embodiments, the core material can be foamed (either open cell or closed cell), such as polyurethane. In still further embodiments, the core is made from multiple materials (such as those listed above), either as a heterogeneous mass, multiple layers or defined sections. Any of the above materials may also be provided with antistatic or antibacterial properties, e.g., by the inclusion of silver flakes, powders or particles, carbon black, ceramics, or other metals or alloys. Preferred plastics include extrudable and/or moldable thermosetting and thermoplastic resins, the latter including high density olefins and polyvinylchloride.

The core is typically in the form of a rectangular prism with parallel broad faces. On one or both faces is typically a décor. The décor, generally in a layer, typically includes a laminate which can be formed as a single, unitary, monolithic surface. This décor may be decorated, for example, with a laminate or a paper, such as a monochromatic or patterned décor, optionally impregnated with a resin, in order to increase its aesthetic value, or blend, to match or contrast with the floor panels or any other décor in the vicinity of the panels. Preferably, the décor layer has incorporated therein at least one material to increase its abrasion resistance, such as hard particles of silica, alumina, diamond, silicon nitride, aluminium oxide, silicon carbide and similar hard particles, preferably particles having a Moh's hardness of at least approximately 6. This first laminate may also be covered with other types of coverings, such as foils (such as metal, paper or thermoplastic foils), paints or a variety of other décorative elements, including, but not limited to wood veneer, ceramic, metal, vinyl or other décorative materials.

The décor may also be formed directly on the core (or a primer layer on the core), as described by, e.g., U.S. Pat. No. 6,465,046 (and other documents), for example by printing on the core. Such a printed décor may be printed directly on the core material by a digital process, such as by a conventional ink jet or laser-type printer. In one embodiment, the core is optionally provided with a solid primer and/or a base color, on which the décorative pattern or display is printed or otherwise generated. While the term “pattern” is used herein, it is to be understood that “pattern” may, but need not be or include any repeating units, thus “pattern” is simply a visual or textual display. Once the décor is complete, the digitally printed décor can be covered with a wear layer (preferably including the hard particles as discussed above), thereby giving the décor abrasion and/or scratch resistance. The wear layer can be provided in the form of a sheet of alpha-cellulose which is bonded to the core, or it can be applied in a liquid form.

Often, the décor is provided with a patterned paper sheet therein, wherein the pattern resembles a natural or synthetic object, such as wood, ceramic, stone (including marble and granite), or fantasy patterns (i.e., those not found in nature), including a monochromatic or random field.

The resulting products typically have durability rating. As defined by the European Producers of Laminate Flooring, such products can have an abrasion resistance rating of anywhere from AC1 to AC5. Typical abrasion resistances are >300 cycles, >400 cycles, >500 cycles, at least 900 cycles (AC1), at least 1800 cycles (AC2), at least 2500 cycles (AC3), at least 4000 cycles (AC4) and at least 6500 cycles (AC5) or even up to AC6, as measured by European Standard EN 13329 (Annex E). Typical products according to the invention can also have impact resistance ratings of IC1, IC2 or IC3, as measured by European Standard EN 13329.

Moreover, it is possible to provide the décor with a texture which enhances the pattern of the underlying paper sheet. Such texturing can be created to be “in register” with offset from, or to contrast with the image of the paper sheet. Such texturing may be created by physical pressing, e.g., embossing (as taught by U.S. Appl. Ser. No. 10/440,317 (filed May 19, 2003), U.S. Pat. No. 7,003,364, and WO9731775 and WO9731776) or chemically created (as taught by U.S. Pat. No. 6,991,830). The texture can be selected by the installer to enhance (e.g., match or contrast with) any texture of adjacent or included surfaces. The texture may also be provided on the décor such that features of the texture extend from a flooring element onto and possible completely across the adjacent flooring elements, which texture may, or may not coincide with the underlying décor.

The preferred example can be made of HDF or MDF materials and covered with a DL (direct laminate) or an HPL (high pressure laminate) on one or both sides of the core, which are typically different, but may be the same. The surface or surfaces are not limited to just laminate covering. Other coverings could be direct printing onto the core or printing onto a primer placed on the core or printing onto a paper placed on the core. Such printing may be digital, direct transfer, or other printing form.

The surface or surfaces may have a multitude of décors, fantasy designs, natural designs, pictorial, as examples of décors. Alternatively one or both of the surface or surfaces may be covered with foil, wood veneer, metal, plastic, vinyl or digitally printed, laser-electrographic, laser etched, direct or ink jet applications with UV cured inks or other forms of printing inks. However, preferably, at least one of the surfaces is a laminate, and the other is selected from the preceding examples.

The surface or surfaces may be textured in a variety of forms, such as to resemble natural wood grain, stone or tile, etc. The texturing can be of the form of registered and embossed or only a smooth or matted finish. When two décors are present on different sides of the core one or both may have the same or different textures or surface qualities in addition to décor design. The surface or surfaces may also be covered with protective coating, lacquer, urethane, or other liquid surface that may contain hard particles or not. These coatings can be UV cured or not.

A sheet of core material, HDF, MDF, particle board or other compositions, plastic, etc. that has a laminate bonded to its surface and also may have a contra laminate or other balancing material on the other side of the sheet. The element is typically 7×8 feet in DL laminate production, but not limited to this size. HPL production can also sheets approximately 4×8 feet.

Although rectangular (e.g., square) panels are preferred, the panels can independently be of any regular or irregular geometric shape, e.g., octagonal, hexagonal, triangular. If the panels are all of the same shape, the dimensions need not be the same, as for example, rectangular panels of varying lengths/widths may be used.

In a preferred exemplary embodiment, the retaining profile can be joined by a relative movement directed perpendicularly to the laying plane. If floor panels are involved, the retaining profiles can be joined by a relative vertical movement (while other edges of the floor panels are joined by any type of relative movement). This vertical movement can be a linear movement or a pivoting movement about an axis running parallel to the laying plane and perpendicular to the lateral edges with the retaining profiles.

The invention is explained in detail with reference to the exemplary embodiments shown in the drawings. In the figures:

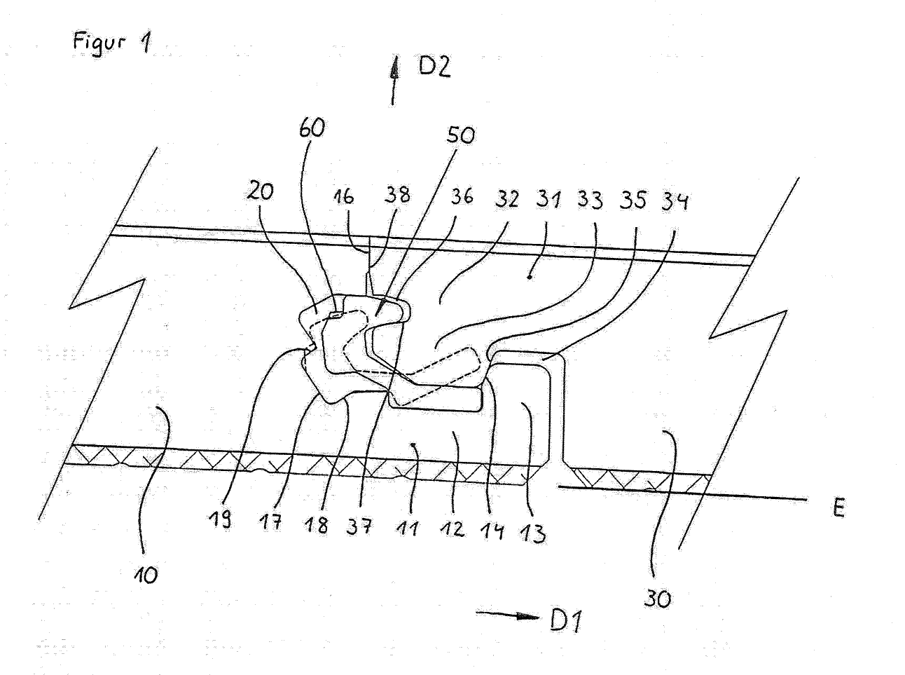

FIG. 1 shows a joining of two panels in the joined state; and

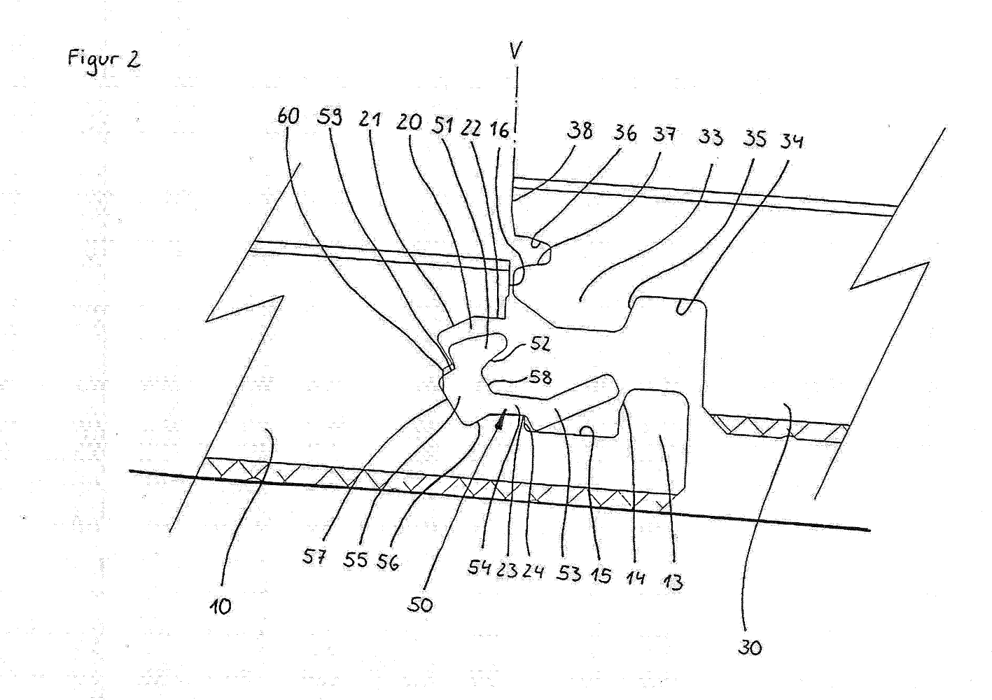

FIG. 2 shows the two panels from FIG. 1 in the non-joined state;

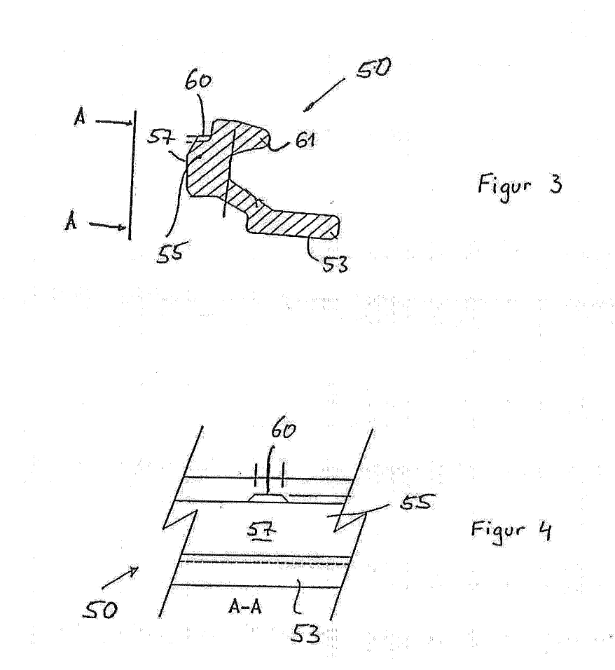

FIG. 3 shows a locking element in cross-section; and

FIG. 4 shows the locking element from FIG. 3 for a specific longitudinal section.

FIG. 1 shows in cutaway view a first panel 10 and a second panel 30 in cross-section. The first panel 10 is joined at a lateral edge 11, to the second panel 30 at a lateral edge 31. In this case, the lateral edges 11, 31 extend perpendicularly to the plane of the drawing in FIG. 1. The panels 10, 30 should be floor panels, a laying plane E extending in the generally horizontal direction.

In contrast to FIG. 1, FIG. 2 shows the panels 10, 30 in a non-joined state. The joint according to FIG. 1 can be made by relatively moving the panel 30 down from the position shown in FIG. 2

As can be deduced from the preferred embodiment of FIG. 1, a first retaining profile 12, comprising an upwardly directed hook element 13, is disposed on the lateral edge 11 of the first panel 10. The retaining profile 12 is joined to a retaining profile 32 of the second panel 30. The second retaining profile has a downwardly directed hook element 33. The hook element 13 engages in a retaining groove 34 and abuts with a mating surface 14, which is substantially vertical or slightly inclined with respect to the vertical, against a corresponding mating surface 35 of the hook element of the second panel. The hook elements 13, 33 or the abutting mating surfaces 14, 35 help to ensure a positive joining of the panels 10, 30 in a direction D1 parallel to the laying plane E.

A separate locking element 50 is associated with the first retaining profile 12. The locking element 50 can occupy at least two different positions. In a locking position as shown by the position indicated by shading in FIG. 1, the locking element 50 engages, when in its locked position, with a locking projection 51 in a locking groove 36 of the second retaining profile 20. In this case, a lower locking surface 52 of the locking projection 50 abuts against a lower groove wall 37 of the locking groove 36. The cooperation of locking projection 51 as well as the locking groove 36 ensures a form closure between the panels 10, 30 in the vertical direction D2 perpendicular to the laying plane E.

Furthermore, the locking element 50 can adopt an assembly position shown by the dashed line in FIG. 1. In this assembly position, the locking projection 51 does not go beyond or goes only slightly beyond a vertical plane V (FIG. 2), defined by the two adjoining upper edges 16, 38 of the panels 10, 30. This means that during a vertical downward movement of the second panel 30 in the direction of the laying plane in order to join the retaining profiles 10, 30, the locking projection initially does not come in contact with the second retaining profile or apart from an end phase of the vertical movement. During the vertical downward movement of the second panel, the upper edge 38 is located substantially continuously in the vertical plane V. It should also be understood Plane V is defined as a vertical plane (i.e., being perpendical to the plane of the upper surfaces of the joined panels) positioned at the distal ends of the panels when joined, even if the upper edges 16, 38 do not define such a plane.

The not-locked position of the locking element 50 is shown in FIG. 2. In this case, the position of the locking element 50 corresponds to the position as indicated by the dashed line in FIG. 1.

The locking element 50 preferably has a leg 53 which is at least partially disposed in a correspondingly configured groove 15, which is preferably horizontal of the first retaining profile 10. When the locking element 50 is located in its assembly (or unlocked) position, the leg 53 is removed from its groove 15, for example inclined obliquely upwards (see dashed line 53′ or FIG. 2).

Leg 53 and locking projection 51 are connected by a web 54 and a body portion 55. The body portion 55 can have a substantially rectangular cross-section (with or without rounded corners) with an underside 56, a rear side 57, a front side 58 and an upper side 59. A bevel 60 is typically provided between rear side 57 and upper side 59.

In the embodiment shown in FIG. 2, in the assembly position, the locking element 50 lies with the body portion 55 in a retaining groove 17 which comprises a lower groove wall 18 and an upper groove wall 19. The distance of the groove walls 18, 19 and the body portion 55 are determined or designed in such a manner that a press fit or tight fit is provided between body portion 55 and the retaining groove by which means the body portion 55 and therefore also the locking projection 51, connected fixedly or substantially fixedly to said body portion, is fixed non-positively or fictionally connected.

Provided on the upper side 59 of the body portion can be elevations 60 which contribute to the press fit or make the press fit occur. As can be deduced from the elevation 60 in the assembly position (see dashed line in FIG. 1) or FIG. 2, an overlap of elevation 60 and upper groove wall 19 comes about. The locking element 50 with its body portion 55 can be inserted by being pressed with force into the retaining groove 17. The direction in which the locking element can be inserted into the retaining groove 17 corresponds to the alignment of the groove walls 18, 19.

Adjoining the retaining groove 17 is preferably a recess 20 in the retaining profile 11 for receiving the locking projection 51 when in the assembly position. Towards the top, the recess is delimited by a groove wall 21 and an adjoining groove wall 22 at an angle thereto. The groove wall 22 runs horizontally and serves as an upper abutment for the locking projection 51 when the locking element 50 is located in the locking position.

FIG. 1 shows the retaining profiles 11, 31 in the joined state. In a preferred embodiment, in order to join the profiles 11, 31 the panel 30 is lowered from above, the upper edge 38 remaining in the plane V (cf. also FIG. 2). During the lowering, an underside 39 of the hook element 33 impacts against the upwardly projecting leg 53 (see FIG. 2). This leg 53 is resiliently deformed when the panel is lowered further since the body portion 55 sits firmly in the retaining groove 17. Only when the pressure from the second panel 30 being exerted on the leg 53 and ultimately on the entire locking element 50 becomes too great, does the body portion 55 become released from the retaining groove 17. The locking element 50 thereby executes a tilting movement about a point defined by the upper edge 23 of a groove wall 24 of the groove 15. Due to the tilting movement, the locking projection 51 pivots into the locking groove 36. At the same time, a temporary deformation of the web 54 and/or the body portion 55 may occur. In an alternate embodiment, the first profile 11 deforms alone or in combination with the web 54 and/or the body portion 55.

FIG. 3 shows the locking element 50 in a slightly modified form. Compared to the exemplary embodiment in FIGS. 1 and 2, the locking projection 51 has a rounded tip 61. It can be seen from FIG. 4, which shows a view along the line A-A in FIG. 3, that located on the upper side 59 of the body portion 55 is an elevation 60 which does not extend over the full length in the longitudinal direction of the locking element 50. A plurality of elevations 60 can be provided, having a distance from one another of, for example, 2, 4 or 6 cm. The dimension of the press fit or tight fit and therefore also the retaining force between retaining groove 17 and body portion 55 can be adjusted by means of the number of elevations 60 and their shape. The elevations 60 can also be replaced by a continuous web.

1. A set of panels, comprising
a first panel having a lateral edge on which a first retaining profile is disposed,
at least one second panel having a lateral edge on which a second retaining profile is disposed, which can be joined to the first retaining profile,
wherein the panels are joined positively along the lateral edges by the retaining profiles in a direction parallel to a laying plane and in a direction perpendicular to the laying plane in the joined and laid state of the panels;
a separate locking element associated with the first retaining profile which, during joining of the retaining profiles, moves from an assembly position into a locking position,
wherein in a locking position the locking element ensures form closure at least in a direction perpendicular or parallel to the laying plane by a locking projection of the locking element engaging in a locking recess provided on the second retaining profile,
characterised in that
the first retaining profile and/or the locking element have retarding means which, on transition from the assembly position into the locking position, retard a movement of the locking projection in such a manner that a deformation stress is built up in the locking element during joining of the retaining profiles without the locking projection thereby resting on a surface of the second retaining profile.

2. The set of panels according to claim 1, characterised in that the first retaining profile comprises an upwardly directed hook element and the second retaining profile comprises a downwardly directed hook element, wherein the hook elements ensure form closure in the direction parallel to the laying plane in the joined state.

3. The set of panels according to claim 1, characterised in that the retarding means comprise a press fit or tight fit which is established between the locking element and the first retaining profile when the locking element is located in the assembly position.

4. The set of panels according to claim 3, characterised in that the locking element has a plurality of elevations which are spaced apart from one another along a longitudinal extension, which lead to a press fit in cooperation with the partial region of the first retaining profile.

5. The set of panels according to claim 1, characterised in that the retarding means comprise adhesive or the like.

6. The set of panels according to claim 1, characterised in that the locking element is formed in one piece.

7. The set of panels according to claim 1, characterised in that the locking element is formed from a plurality of parts with different materials.

8. The set of panels according to claim 1, characterised in that the locking element has a leg against which the second retaining profile presses substantially in a direction perpendicular to the laying plane during the joining of the retaining profiles.

9. The set of panels according to claim 1, characterised in that the retarding means exert a force on the locking projection which exceeds 20 N per linear meter in the direction of a longitudinal extension of the locking element.

10. The set of panels according to claim 9, characterised in that the retarding means exert a force on the locking projection which exceeds 100 N per linear meter.

11. A system for forming a substantially planar surface comprising:
a first panel comprising a first profile on an edge thereof, the first profile comprising a retaining groove;
a second panel comprising a second profile on an edge thereof, the second profile comprising a locking groove and having a size and shape permitting mating with the first profile; and
a locking element comprising a locking projection and a web, wherein the web is held in the retaining groove by a retarding means.

12. The system of claim 11, wherein the retarding means provides a retaining force, capable of maintaining the locking element in its position, and comprises at least one of the group consisting of:
a portion of the locking element formed of a deformable material;
a portion of the first profile formed of a deformable material; and
an adhesive or magnetic material.

13. A method of forming a substantially planar surface, the surface comprising a first panel having a first profile on an edge thereof and a retaining groove in the first profile; a second panel having a second profile on an edge thereof and locking groove in the second profile; and a locking element comprising a locking projection; the method comprising the steps of:
relatively vertically joining the first profile and the second profile; and
moving the locking element from a first assembly position to a second assembled position, such that the locking projection engages the locking groove of the second profile;
wherein the moving step comprises overcoming forces retaining the locking profile in the assembly position.

14. The method of claim 13, wherein the locking element comprises a deformable section located in the retaining groove and the moving step comprises deforming the section as to permit the section to be removed from the retaining groove.
